(19) United States
(12) Patent Application Publication
(10) Pub. No.: US 2010/0278685 A1
(43) Pub. Date: Nov. 4, 2010

(54) PRODUCTION OF TITANIUM TRIFLUORIDE

(76) Inventor: Gerard Pretorius, Lyttelton (ZA)

Correspondence Address: FITCH EVEN TABIN & FLANNERY, 120 SOUTH LASALLE STREET, SUITE 1600, CHICAGO, IL, 60603-3406, US

(21) Appl. No.: 12/811,981

(22) PCT Filed: Dec. 29, 2008
(86) PCT No.: PCT/IB2008/055559

§ 371 Date: Jul. 7, 2010

(30) Foreign Application Priority Data
Jan. 14, 2008 (ZA) 2008/00404

(51) Int. Cl. C01G 23/02; C01B 21/084; C22C 14/00

(52) U.S. Cl. 420/417; 423/489; 423/386

(57) ABSTRACT

A method for the production of titanium trifluoride from a titanium-containing material, includes the steps of producing a fluoride solution of Ti(IV) from the titanium-containing material and reducing the Ti(IV) in the solution with a transition metal or an alloy of the transition metal. The transition metal is selected from manganese, iron, cobalt, nickel and zinc. An ammonium containing salt and either ammonia or ammonium fluoride are added to the resulting solution containing Ti(III) to produce a precipitate, and the precipitate is pyrolysed to produce titanium trifluoride.

THIS INVENTION relates to the production of titanium trifluoride (TiF₃).

As described in WO 2006/079887 A2, TiF3 is a preferred intermediate to produce Ti metal after reduction with reducing agents like Al, Mg, Na or Ca.

The present invention provides an efficient and inexpensive process for the production of titanium trifluoride.

The Applicant is aware of WO 2006/079887 A2 in which TiF₃ is produced from titanium-containing materials such as ilmenite by the reduction of (NH₄)₂TiF₆. However, this process requires the reduction of Ti(IV) with aluminium and is, accordingly, a more expensive process than that of the present invention. The method of the present invention provides an inexpensive process for reducing Ti(IV) to Ti(III).

In acid conditions, transition metals M and alloys thereof, in which M may be manganese, iron, cobalt, nickel or zinc can reduce Ti(IV) to Ti(III). Further, because these metals have a lower affinity for fluoride ions than titanium, it is possible to form NH₄TiF₄ or other fluoride complexes without interference from M. However, the M²⁺ ion has to be stabilized to prevent it from oxidation and co-precipitation. The Applicant has found that oxidation and co-precipitation of the metal can be prevented by the formation of an ammonium double salt (NH₄)₂MCl₄ by adding NH₄Cl (about 4.4 mol per mol of M²⁺) or (NH₄)₂SO₄ (about 2.2 mol per mol of M²⁺) to the reduction solution.

The Applicant has found that a buffering solution results with the addition of NH₄OH or NH₄F which stabilizes the pH of the reduction solution at between 4-5. It is postulated that under these conditions, NH₄OH or NH₄F forms an unusual complex, NH₄TiF₄.NH₄OH or NH₄TiF₄.NH₄F which precipitates from the solution. This complex is stable even when dried. The M²⁺ can then be washed from this complex to leave a clean precursor which can be decomposed to produce TiF₃.

According to a first aspect of the invention, there is provided a method for the production of titanium trifluoride from a titanium-containing material, the method including the steps of
producing a fluoride solution of Ti(IV) from the titanium-containing material,
reducing the Ti(IV) in the solution with a transition metal or an alloy of the transition metal, in which the transition metal is selected from manganese, iron, cobalt, nickel and zinc to produce a solution containing Ti(III),
adding an ammonium containing salt and either ammonia or ammonium fluoride or a mixture thereof to the solution containing Ti(III) to produce a precipitate, and
pyrolising the precipitate to produce titanium trifluoride.

The above metals all have redox potentials which favour the reduction of Ti(IV) to Ti(III) and produce M²⁺ under the conditions of the reduction. They also form the ammonium double salt (NH₄)₂MCl₄ on addition of NH₄Cl or (NH₄)₂SO₄ in the ratios as set out above.

Producing the solution of Ti(IV) from the titanium-containing material may be by digesting the material in an aqueous solution of HF, The ammonium containing salt may be ammonium chloride. Without being bound by theory, the applicant believes that the precipitate is either NH₄TiF₄.NH₄OH or NH₄TiF₄.NH₄F respectively.

The titanium-containing material may be selected from titanium oxides, hydroxides and sulphates, including materials such as rutile, anatase, brookite, pseudo-brookite, and leucoxene, which are all TiO₂ containing materials, and titaniferous slags. Titaniferous slag is a TiO₂-containing material produced largely from the smelting of ilmenite. Ilmenite (FeTiO₃) may also be used in the method of the invention but would require larger amounts of HF and would produce larger amounts of by products.

The method may include reducing the Ti(IV) with iron. The iron may be in the form of iron plates, lumps, powder, iron-containing alloys and the like.

The concentration of the aqueous HF solution may be between about 5-60%, preferably between about 10-30% and, more preferably between about 15 and 25%.

The invention extends to titanium trifluoride prepared by a method as herein described.

The invention extends further to titanium metal prepared from titanium trifluoride produced by a method as herein described.

The invention extends further to the complex salt NH₄TiF₄.NH₄OH.

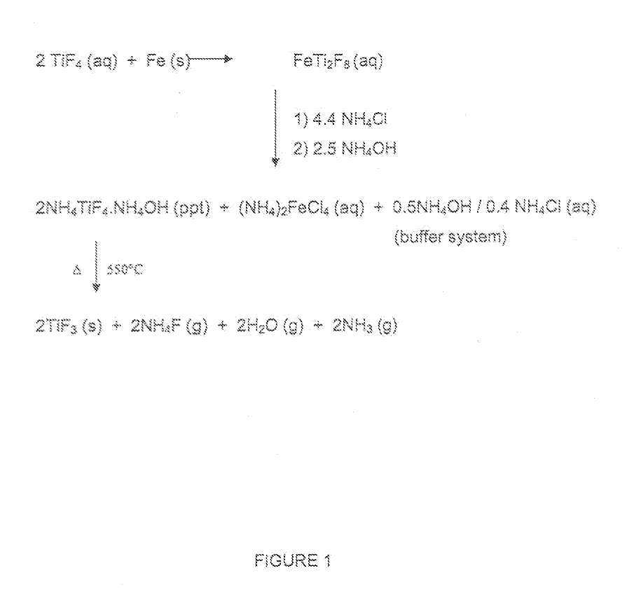

The invention is now described, by way of example, with reference to the following Example and FIG. 1 which shows the reduction of TiF₄ to TiF₃.

### EXAMPLE 1

### Production of TiF₃ Using Iron as the Reducing Agent

In a 5 l polypropylene beaker, HF (2400 g, 40%) was diluted with tap water (2100 g). Anatase pulp (1.25 kg, approximately 50% Ti) was slowly added to the diluted acid with stirring. The dissolution reaction was exothermic and the temperature rose to 60-70° C. After about one hour, the excess pulp was filtered from the solution.

TiO(OH)₂(s)+4HF(aq)→TiF₄(aq)+2H₂O

The aqueous TiF₄ leachate was then standardized. An excess of (NH₄)₂CO₃ was slowly added to a sample of the leachate (75 g) in an alumina crucible (250 ml) until no further white precipitate formed. The precipitate was heated to dryness on a hot plate and the crucible was placed in a furnace at 1000° C. After decomposition (at which point no further fuming took place) the yield of TiO₂, after cooling was 10.2 g, indicating that 587.5 g of leachate is required to produce 1 mol of TiO₂ (79.9 g).

The leachate (2940 g, equal to 5 mol TiO₂), was diluted with tap water (980 g) in a 5 l polypropylene beaker. While slowly stirring, two mild steel plates were lowered into the solution. The total surface submersed in the solution was approximately 3000 cm². Although 40% of the reaction had completed within the first two hours, the reaction was left overnight (18 h) to complete. The reduction of Ti(IV) with iron does not proceed further than Ti(III). The mild steel plates were lifted from the dark green solution, dried and weighed. It was found that 147.6 g (2.643 mol) iron had dissolved.

To stabilize the Fe(II) in solution, 4.4 mol NH₄Cl (10% excess) was added with stirring (2.643×4.4×53.5 g /mol=622 g NH₄Cl) for each mol of iron to form the double salt (NH₄)₂FeCl₄. After 30 minutes, when all the NH₄Cl had dissolved, aqueous ammonia (NH₄OH) was slowly added to the solution. It was found that 2.5 mol NH₄OH (496 ml, 25% solution) added to 1 mol Fe(II) under these conditions resulted in a high yield of a violet precipitate of (what is believed to be) NH₄TiF₄.NH₄OH without co-precipitation of Fe(II) [(2.643×2.5×75 ml/mol NH₄OH (25%)]. After 30 minutes the precipitate was filtered and the filter cake was washed with 0.01 N acetic acid solution until the filtrate was clear. The precipitate was then dried at 70° C. to produce a violet cake (846.6 g). A portion of the cake (50 g) was decomposed under N₂ in an alumina crucible with a graphite lid for 12 hours at 550° C. A strong smell of ammonia was noted and after cooling, a dark brown powder (29.6 g) was produced which was shown by XRD and XRF analysis to be TiF₃.

The mass loss of 40.8% implied that 846.6 g of the violet precursor yielded 501.2 g TiF₃. With a molar mass of 104.9 g, this was equal to 4.78 mol TiF₃, obtained from 5 mol TiF₄ leachate (95.6% efficiency).

The buffer system (excess NH₄Cl and NH₄OH) improved the stability of pH 4-5 during the NH₄OH addition and improved the yield without co-precipitation of the Fe(II).

The mass of TiF₃ (104.9 g/mol) obtained by decomposition of (what is believed to be) NH₄TiF₄.NH₄OH, (176.9 g/mol) is theoretically 59.3%. The yield of TiF₃ obtained was 59.2%, indicating an almost quantitive conversion.

### EXAMPLE 2

### Production of TiF₃ Using Manganese, Cobalt, Nickel or Zinc

Reductions were carried out on the leachate of Example 1 using, respectively, manganese, cobalt, nickel and zinc as the reducing agent to produce TiF₃.

In the case of reduction with iron, the off gases formed during the decomposition of the precipitate were scrubbed with slaked lime to form CaF₂ and NH₄OH. The (NH₄)₂FeCl₄ stream is the same as that described in WO 2006/079887 A2, but produces approximately 50% less Fe per unit of Ti.

The NH₄Cl did not need to be purified or crystallized, it was added as a saturated solution and water was added for the NH₄Cl to dissolve.

Particularly, in the case of iron, the advantages of the method of the present invention over those of the process described in WO 2006/079887 A2 are:
i) crude anatase can be used,
ii) Fe is a much cheaper reducing agent than Al powder,
iii) there is a 35% saving in HF cost (4 mol HF per Ti instead of 6 mol),
iv) the amount of CaF₂ and Fe which has to be removed in the recycling loops is approximately 50% less than that of the WO 2006/079887 A2 process,
v) NH₄Cl can be recycled as a saturated solution instead of as a dry powder, and
vi) 25% less AlF₃ needs to be sublimed in the final product.

The process described in WO 2006/079887 A2 produces a mixture of TiF₃ (75-80 wt %) and AlF₃ (25-20 wt %) from (NH₄)₂TiF₆ via Al reduction. Like titanium, aluminium also has a high affinity for fluoride. This results in the co-precipitation of (NH₄)₃AlF₆ with NH₄TiF₄ during reduction when Al competes against Ti for fluoride ions. When this mixture of precursors is decomposed it results in a TiF₃-AlF₃ mixture. The method of the present invention produces a pure TiF₃ product using Fe as a reducing agent.

1. A method for the production of titanium trifluoride from a titanium-containing material, the method
producing a fluoride solution of Ti(IV) from the titanium-containing material,
reducing the Ti(IV) in the solution with a transition metal or an alloy of the transition metal, in which the transition metal is selected from the group consisting of manganese, iron, cobalt, nickel and zinc to produce a solution containing Ti(III),
adding an ammonium containing salt and either ammonia or ammonium fluoride or a mixture thereof to the solution containing Ti(III) to produce a precipitate, and
pyrolising the precipitate to produce titanium trifluoride.

2. The method as claimed in claim 1, in which the solution of Ti(IV) is produced from the titanium-containing material by digesting the titanium-containing material in an aqueous solution of HF.

3. The method as claimed in claim 1, in which the ammonium containing salt is ammonium chloride.

4. The method as claimed in claim 1, in which the titanium-containing material is selected from the group consisting of titanium oxides, titanium hydroxides, titanium sulphates and titaniferous slags.

5. The method as claimed in claim 4, in which the titanium-containing material is selected from the group consisting of rutile, anatase, brookite, pseudo-brookite, leucoxene and ilmenite

6. The method as claimed in claim 1, in which the Ti(IV) is reduced with iron or an iron containing alloy.

7. The method as claimed in claim 1, in which the concentration of the aqueous HF solution is between about 5 and 60%

8. The method as claimed in claim 7, in which the concentration of the aqueous HF solution is between about 10 and 30%.

9. The method as claimed in claim 8, in which the concentration of the aqueous HF solution is between about 15-25%.

10. A complex salt comprising NH₄TiF₄.NH₄OH.

11. Titanium trifluoride prepared by a method as claimed in claim 1.

12. Titanium metal prepared from titanium trifluoride produced by a method as claimed in claim 1.
